(19) United States
(12) Patent Application Publication
(10) Pub. No.: US 2016/0162972 A1
(43) Pub. Date: Jun. 9, 2016

(54) SYSTEMS AND METHODS OF CURATION AND RECOMMENDATION OF APPLICATIONS AND ACCESSORY DEVICES TO PROVIDE EXPANDED USER EXPERIENCE

(71) Applicant: Google Inc., Mountain View, CA (US)

(72) Inventors: Andrew Abramson, Sunnyvale, CA (US); Benjamin David Poiesz, Santa Clara, CA (US)

(21) Appl. No.: 14/561,362

(22) Filed: Dec. 5, 2014

(51) Int. Cl. G06Q 30/06

(52) U.S. Cl. CPC G06Q 30/0631

(57) ABSTRACT

Systems and methods of recommending at least one new accessory device to provide an expanded user experience with one or more of the applications stored on a user device are disclosed that include retrieving, by a server, device information data from a user device, retrieving, by the server, accessory information data from one or more accessory devices determined to be communicatively coupled to the user device within a predetermined period of time according to the retrieved device information data, retrieving, by the server, application data from the user device for applications stored on the user device, and recommending, by the server that is communicatively coupled to a storage device having a database of applications and user experience data, at least one new accessory device to the user device according to user experience data, the retrieved application data, the retrieved device information data, and the accessory information data.

### BACKGROUND

Applications for electronic devices, which may be commonly referred to as “apps”, are typically selected for download to an electronic device from a database of applications for a particular operating system of an electronic device. The database of applications is typically accessible via the Internet from a web browser stored on the electronic device, or from an application stored on the electronic device which can access the database of applications. Typically, such databases of applications that can be searched, selected, downloaded is commonly referred to as an “app store.” When a user browses or searches for applications in the app store using an electronic device, the store does not know what accessory devices are owned by the user, or have been communicatively coupled to the user's electronic device. This can lead to situations where the app store does not provide useful recommendations to the user of the electronic device.

### BRIEF SUMMARY

According to embodiments of the disclosed subject matter, systems and methods are provided to recommend accessory devices to provide an expanded user experience with one or more of the applications stored on a user device, and recommend content, such as other applications, which leverages the accessories associated with the user device.

According to an embodiment of the disclosed subject matter, a method is provided that includes retrieving, with a server, device information data from a user device, retrieving, by the server, accessory information data from one or more accessory devices determined to be communicatively coupled to the user device within a predetermined period of time according to the retrieved device information data, retrieving, by the server, application data from the user device for applications stored on the user device, and recommending, by the server that is communicatively coupled to a storage device having a database of applications and user experience data, at least one new accessory device to the user device according to user experience data, the retrieved application data, the retrieved device information data, and the accessory information data.

According to an embodiment of the disclosed subject matter, a system is provided that includes a user device, one or more accessory devices determined to be communicatively coupled to the user device within a predetermined period of time, a server, communicatively coupled to a storage device having a database of applications and user experience data, to retrieve device information data from the user device, accessory information data from the one or more accessory devices according to the retrieved device information data, and application data from the user device for applications stored on the user device, and to recommend at least one new accessory device to the user device according to user experience data, the retrieved application data, the retrieved device information data, and the accessory information data.

According to an embodiment of the disclosed subject matter, means for recommending at least one new accessory device to provide an expanded user experience with one or more of the applications stored on a user device by retrieving, with a server, device information data from a user device, retrieving, by the server, accessory information data from one or more accessory devices determined to be communicatively coupled to the user device within a predetermined period of time according to the retrieved device information data, retrieving, by the server, application data from the user device for applications stored on the user device, and recommending, by the server that is communicatively coupled to a storage device having a database of applications and user experience data, at least one new accessory device to the user device according to user experience data, the retrieved application data, the retrieved device information data, and the accessory information data.

Additional features, advantages, and embodiments of the disclosed subject matter may be set forth or apparent from consideration of the following detailed description, drawings, and claims. Moreover, it is to be understood that both the foregoing summary and the following detailed description are illustrative and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a computing device according to an embodiment of the disclosed subject matter.

FIG. 2 shows a network configuration according to an embodiment of the disclosed subject matter.

FIG. 3 shows a network configuration, where one or more accessory devices are communicatively coupled to a user device directly, as well as via a network, according to an embodiment of the disclosed subject matter.

FIG. 4 shows an example network and system configuration according to an embodiment of the disclosed subject matter.

FIG. 5 shows a method of recommending at least one new accessory device to provide an expanded user experience with one or more of the applications stored on a user device according to an embodiment of the disclosed subject matter.

### DETAILED DESCRIPTION

Exemplary embodiments of the presently disclosed subject matter may provide systems and method of providing recommendations for accessory devices for a user's computing device to expand the user experience for the user with one or more applications (e.g., applications stored on the user's device). With the system disclosed herein, an application store (i.e., “app store”) may provide accessory device and application recommendations to a user device, and may cross-link between these products so that users can be made aware that user experiences with existing purchases and/or downloads can be expanded, and that hardware-software dependencies may exist between one or more applications and accessory devices.

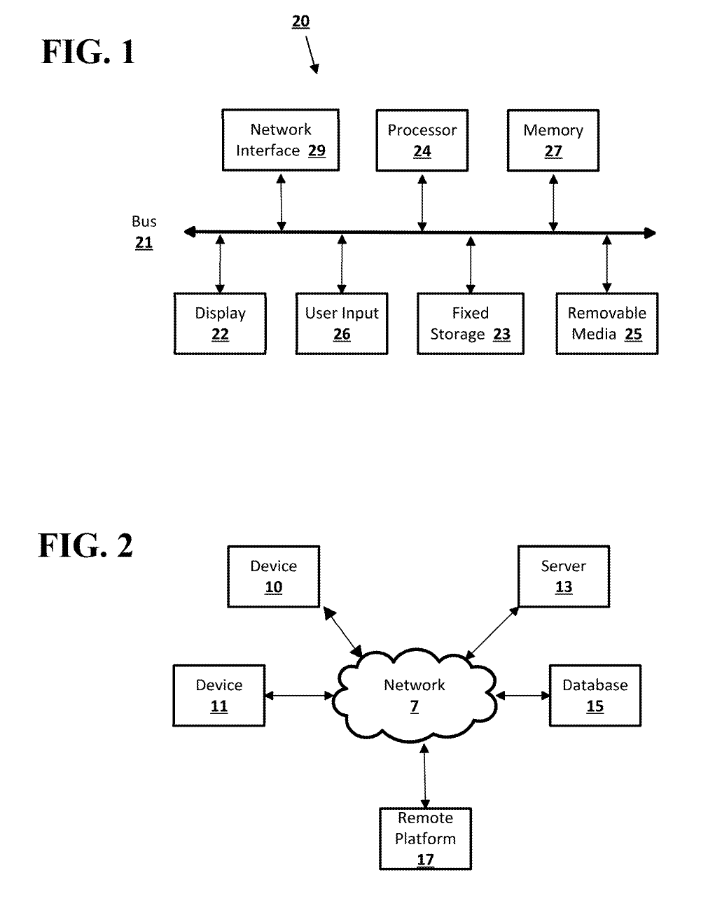

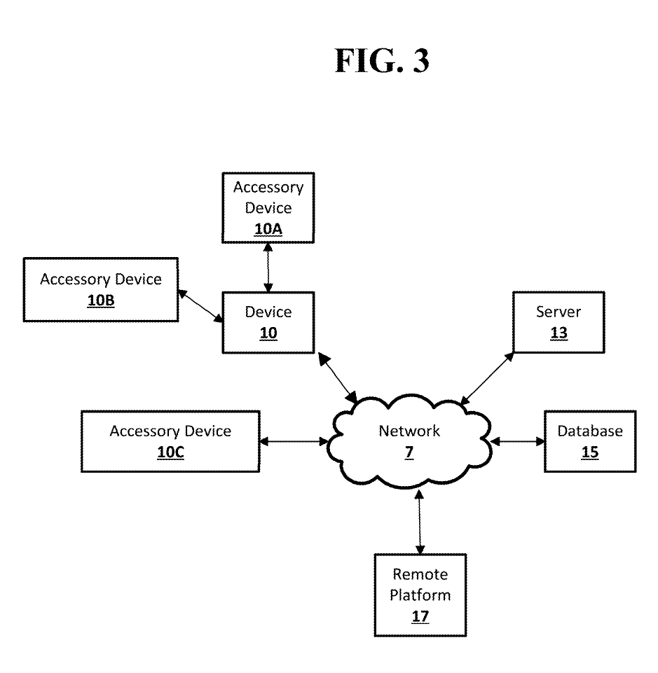

Embodiments of the presently disclosed subject matter may be implemented in and used with a variety of component and network architectures. FIG. 1 is an example computing device 20 suitable for implementing embodiments of the presently disclosed subject matter. That is, the computing device 20 may be a user device to which accessory devices may be communicatively coupled, and which may store one or more applications. The device 20 may be, for example, a desktop or laptop computer, or a mobile computing device such as a smart phone, tablet, or the like. The device 20 may include a bus 21 which interconnects major components of the computing device 20, such as a central processor 24, a memory 27 such as Random Access Memory (RAM), Read Only Memory (ROM), flash RAM, or the like, a user display 22 such as a display screen, a user input interface 26, which may include one or more controllers and associated user input devices such as a keyboard, mouse, touch screen, and the like, a fixed storage 23 such as a hard drive, flash storage, and the like, a removable media component 25 operative to control and receive an optical disk, flash drive, and the like, and a network interface 29 operable to communicate with one or more remote devices via a suitable network connection. The bus 21 may also connect one or more accessory devices (e.g., accessory devices 10A and 10B, as illustrated in FIG. 3 and discussed below) with the major components of the computing device 20. In addition, or alternatively, one or more accessory devices may be communicatively coupled to the computing device 20 via the network interface 29.

The bus 21 allows data communication between the central processor 24 and one or more memory components, which may include RAM, ROM, and other memory, as previously noted. Typically RAM is the main memory into which an operating system and application programs are loaded. A ROM or flash memory component can contain, among other code, the Basic Input-Output system (BIOS) which controls basic hardware operation such as the interaction with peripheral components. Applications resident with the computing device 20 are generally stored on and accessed via a computer readable medium, such as a hard disk drive (e.g., fixed storage 23), an optical drive, floppy disk, or other storage medium. At least one of the memory 27, the fixed storage 23, and the removable media 25 may store one or more applications (i.e., “apps”).

The fixed storage 23 may be integral with the computer 20 or may be separate and accessed through other interfaces. The network interface 29 may provide a direct connection to a remote server via a wired or wireless connection. The network interface 29 may provide such connection using any suitable technique and protocol as will be readily understood by one of skill in the art, including digital cellular telephone, WiFi, Bluetooth®, near-field, and the like. For example, the network interface 29 may allow the computer to communicate with other computers via one or more local, wide-area, or other communication networks, as described in further detail below. The network interface 29 may allow the computing device 20 to communicate with accessory devices via one or more local, wide-area, or other communication networks.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an embodiment of the disclosed subject matter. One or more devices 10, 11, such as local computers, smart phones, tablet computing devices, game consoles, set-top boxes, home media servers, and the like may connect to other devices via one or more networks 7. Each device may be a computing device as previously described. Additionally, or alternatively, device 11 may be an accessory device to computing device 10. The network may be a local network, wide-area network, the Internet, or any other suitable communication network or networks, and may be implemented on any suitable platform including wired and/or wireless networks. The devices may communicate with one or more remote devices, such as servers 13 and/or databases 15. The remote devices may be directly accessible by the devices 10, 11, or one or more other devices may provide intermediary access such as where a server 13 provides access to resources stored in a database 15. The devices 10, 11 also may access remote platforms 17 or services provided by remote platforms 17 such as cloud computing arrangements and services. The remote platform 17 may include one or more servers 13 and/or databases 15. An application store, which may include a database of applications for the devices 10, 11 may be included in the server 13, the database 15, and/or the remote platform 17. The application store may provide recommendations to devices 10, 11 for accessory devices and/or applications to expand the user experience of the devices 10, 11. That is, the recommended accessory devices and/or applications may expand the user experience of the applications already stored on the devices 10, 11 and one or more accessory devices communicatively coupled to the devices 10, 11.

FIG. 3 shows an example network arrangement according to an embodiment of the disclosed subject matter, which is similar to the example network arrangement illustrated in FIG. 2 and described above. As shown in FIG. 3, device 10 can be communicatively coupled to accessory device 10A and/or accessory device 10B. Although only accessory devices 10A and 10B are shown as being directly communicatively connected to the device 10, this is merely an example of the number of accessory devices that can be coupled. Any suitable number of accessory devices may be communicatively coupled to the device 10, and the number and/or type of accessory devices can change. That is, the user can communicatively couple and decouple accessory devices (e.g., accessory devices 10A, 10B, etc.) from the device 10. Alternatively, or in addition, accessory devices such as accessory device 10C may be communicatively coupled to the device 10 via the network 7. Although only accessory device 10C is shown as being communicatively connected to the device 10 via the network 7, this is merely an example of the number of accessory devices that can be coupled. Any suitable number of accessory devices may be communicatively coupled to the device 10 via the network 7, and the number and/or type of accessory devices can change.

As disclosed herein, and as illustrated in FIG. 3, an accessory device (e.g., accessory device 10A, 10B, or 10C and the like) may be a game controller, a video device accessory, a virtual reality headset, a display device (e.g., a TV display or monitor), a keyboard or other user input device (e.g., a headset), a wearable computing device (e.g., wearable computing glasses, watch, or the like), an automobile, and the like.

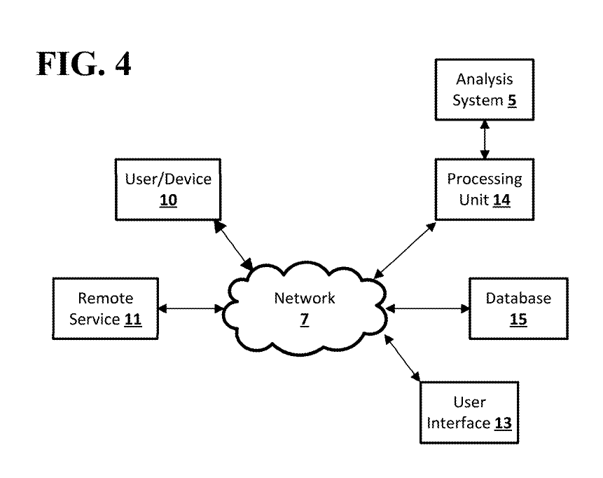

FIG. 4 shows an example arrangement according to an embodiment of the disclosed subject matter. One or more devices or systems 10, 11, such as remote services or service providers 11, user devices 10 such as local computers, smart phones, tablet computing devices, and the like, may connect to other devices via one or more networks 7. The service provider 11 may be an application store that may provide recommendations to device 10 for accessory devices and/or applications to expand the user experience of the user devices 10. The network may be a local network, wide-area network, the Internet, or any other suitable communication network or networks, and may be implemented on any suitable platform including wired and/or wireless networks. The devices 10, 11 may communicate with one or more remote computer systems, such as processing units 14, databases 15, and user interface systems 13. In some cases, the devices 10, 11 may communicate with a user-facing interface system 13, which may provide access to one or more other systems such as a database 15, a processing unit 14, or the like. For example, the user interface 13 may be a user-accessible web page that provides data from one or more other computer systems. The user interface 13 may provide different interfaces to different clients, such as where a human-readable web page is provided to a web browser client on a user device 10, and a computer-readable API or other interface is provided to a remote service client 11.

The user interface 13, database 15, and/or processing units 14 may be part of an integral system, or may include multiple computer systems communicating via a private network, the Internet, or any other suitable network. One or more processing units 14 may be, for example, part of a distributed system such as a cloud-based computing system, search engine, content delivery system, application store, or the like, which may also include or communicate with a database 15 and/or user interface 13. In some arrangements, an analysis system 5 may provide back-end processing, such as where stored or acquired data is pre-processed by the analysis system 5 before delivery to the processing unit 14, database 15, and/or user interface 13. For example, a machine learning system 5 may provide various prediction models, data analysis, or the like to one or more other systems 13, 14, 15. In another example, the analysis system 5 may determine information about the user device 10, as well as whether any accessory devices have been communicatively coupled to the user device 10 (e.g., either presently coupled, or that have been coupled within a predetermined period of time, such as within minutes, hours, days, or weeks, and so forth). The analysis system 5 may also determine the applications that are stored on the user device 10, and may provide recommendations for one or more accessory devices for the user to purchase and/or couple to the user device 10 to expand the experience of one or more applications stored on the user device 10, and may provide recommendations to the user device 10 for applications to be retrieve from, for example, the database 15 and/or the service provider 11.

In situations in which the systems discussed here (e.g., as illustrated in FIGS. 1-4) collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In particular, users may control whether to permit a user device 10 to transmit data related to the applications stored on the user device, the accessory devices that have been connected to the user device, and related to the user device itself. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a system as disclosed herein.

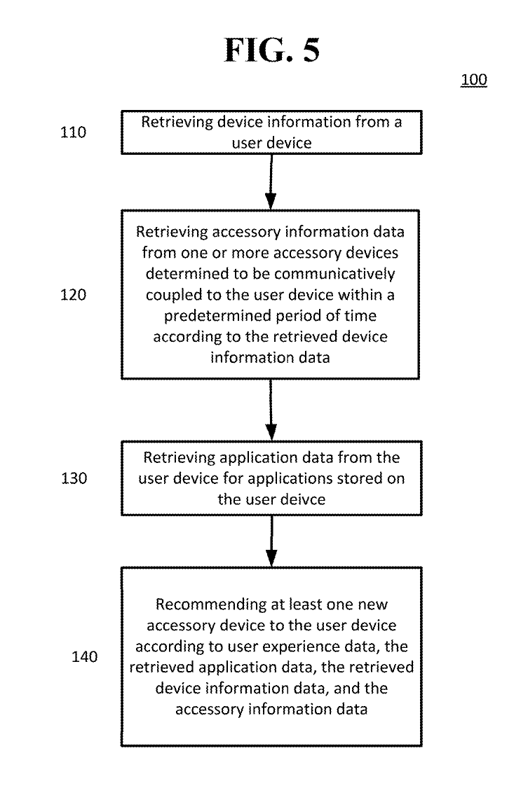

FIG. 5 shows a method 100 of recommending at least one new accessory device to provide an expanded user experience with one or more of the applications stored on a user device (e.g., device 10 illustrated in FIGS. 1-3) according to an embodiment of the disclosed subject matter. In operation 110, a server, such as sever 13 shown in FIGS. 2-3, can retrieve device information data from a user device. The device information can include, for example, the make (i.e., manufacturer), the model, the operating system version, available memory, and/or any other suitable device information so that the server 13 can identify the user device. In operation 120, the server can retrieve accessory information data from one or more accessory devices (e.g., accessory device 10A, 10B, and/or 10C) determined to be communicatively coupled to the user device. The accessory devices may be presently connected to the user device, or may have been connected to the user device within a predetermined period of time (e.g., within the last 5 minutes, 10 minutes, 30 minutes, 1 hour, 1 day, 1 week, 1 month, 6 months, or the like). The accessory information data may include, for example, the make (i.e., manufacturer), the model, capability information, and any other suitable information regarding the accessory device and it operating modes, features, and capabilities.

Application data can be retrieved by the server from the user device, where the application data relates to applications stored on the user device, at operation 130. Application data may include, for example, the name and the version of one or more applications stored on the user device, as well as hardware, operating system, or accessory requirements for basic operating and/or functionality, as well as hardware and/or accessory requirements to provide an expanded user experience.

In operation 140, the server that is communicatively coupled to a database of applications and user experience data may recommend at least one new accessory device to the user device according to user experience data, the retrieved application data, the retrieved device information data, and the accessory information data. That is, the database of applications may include hardware requirements (e.g., the make, model, and/or type of user device) for one or more applications, as well as one or more accessory devices (e.g., the make, model, and/or type of accessory devices) that may be used and/or compatible with an application, as well as which accessory devices may provide an expanded user experience when the application is executed on the user device and the one or more accessory devices are communicatively coupled to the user device.

In example embodiments of the presently disclosed subject matter, the recommended at least one new accessory device in operation 140 can provide an expanded user experience with one or more of the applications stored on the user device, when the user purchases and communicatively couples the recommended accessory device to the user device. The database of applications and user experience data may include data linking one or more accessory devices to one or more applications, respectively, to provide a predetermined expanded user experience with the one or more applications.

The server can determined that the user device is associated with the at least one new accessory device according to updated accessory information data retrieved from the user device. That is, the server may periodically retrieve accessory information from the user device to capture updates to the accessory information (e.g., as accessory devices are coupled and/or decoupled from the user device). Alternatively, or in addition, the user device may provide updated accessory information to the server when accessory devices are newly coupled to and/or decoupled from the user device. The server that is coupled to the storage device having the database of applications and user experience data may recommend at least one new application from the database of applications according to the updated accessory information data. That is, as the device may have accessories communicatively coupled to it, the server may provide recommendations for new applications to provide an expanded user experience with the corresponding accessory device. Alternatively, or additionally, the server may alert and/or inform the user that the user experience with an existing application that is stored on the user device may be expanded, as one or more accessory devices have been communicatively coupled to the user device.

In example embodiments of the presently disclosed subject matter, the server may tag at least one application in the storage device having the database of applications, so that accessory devices for a predetermined user experience level are identified. The user experience levels may also be referred to as feature levels, where an application may have one or more feature levels according to whether the user device has one or more accessory devices coupled to it that the application can interact with.

That is, applications may have one or more user experience levels that may be presented according to the accessory devices that are communicatively coupled to the user device that features of an application can utilize. For example, a first user experience level may be provided by an application when a first accessory device is communicatively coupled to the user device. A user experience level may be expanded to provide a second user experience level when the user had at least a second accessory device communicatively coupled to the user device, along with the first accessory device.

Alternatively, or in addition, applications may be tagged according to manual input (e.g., from application developers of the corresponding application). Applications may be tagged according to features identified in an application by a tagging application that reviews the source code, metadata, and/or other data of the application. Applications may also be tagged by crowdsourcing, whereby users of the application can provide tagging information regarding an application and/or an accessory device as to whether the application is operable with a user device and/or a particular accessory device, or combination of accessory devices. With crowdsourcing, users can provide tagging to identify which combination of applications, user devices, and accessory devices provide an expanded user experience. The crowdsourced tagging provided by one or more users may be provided for one or more user devices to at least of the server 13, the database 17, and/or the remote platform 17 illustrated in FIGS. 2-3, or may be provided to service provider 11, processing unit 14, and/or database 15 illustrated in FIG. 4.

That is, with crowdsourcing, one or more users of device 10 illustrated in FIGS. 2-3 may provide tagging for accessory devices (e.g., accessory devices 10A, 10B, and/or 10C) and/or applications to at least one of the server 13, database 15, and the remote platform 17, where the tagging is associated with data for the respective accessory devices and/or applications. Accordingly, with tagging, users may identify one or more combinations of user devices, accessory devices, and/or applications that provide an expanded user experience when utilized together. At least one of the server 13 and the remote platform 17 illustrated in FIGS. 2-3, or at least one of the remote service 15 and processing unit 14, may store and/or utilize the user-provided tagging information to provide recommendations to the user device for one or more accessory devices and/or applications to expand a user experience.

In example embodiments of the presently disclosed subject matter, the system as disclosed herein may extract data from application and/or accessory device reviews (e.g., retrieved from a server connected to a communications network). The extracted data may be used to tag applications and/or accessory device recommendations to identify accessory devices that may expand the user experience for a particular application.

With the server that is coupled to the database of applications and user experience data, the server can determine at least one application to recommend according to the retrieved device information data and the accessory information data. The server can filter the determined applications to recommend to the user of the user device, according to at least one of the retrieved device information data and the accessory information data.

In example embodiments of the presently disclosed subject matter, the server can recommend the at least one new accessory device without receiving user input from the user device. Typically, in traditional application distribution systems, a user may provide keywords and/or other input as a search query to locate applications that match the query. In contrast, the example embodiments of the present disclosed subject matter provide new accessory device recommendations according to the user experience data, the retrieved application data, the retrieved device information data, and the accessory information data, and may not utilize a user search query received from a user device. In example embodiments of the presently disclosed subject matter, the recommending of the at least one new accessory device by the server can without receiving a search request for at least one of an application and an accessory device from the user device.

According to the tagging disclosed above, at least one of the server 13, database 15, and the remote platform 17 illustrated in FIGS. 2-3 may assign a “badge” to one or more applications available from the server 13, database 15, or the remote platform 17 for the user devices 10, 11 and/or one or more accessory devices 10A, 10B, and 10C. Alternatively, at least one of the remote service 11, database 15, and processing unit 14 illustrated in FIG. 4 may assign a badge to the one or more applications available from the remote service 11, database 15, and processing unit 14 for the user device 10, and any accessory devices coupled to the user device 10. Using the tags, recommendations may be presented to a user device (e.g., from a server) to visually indicate (e.g., using a badge) one or more accessory devices that may provide an expanded user experience for an associated application. For example, an application that is available from a server and/or database as part of an “app store” may include a badge that visually indicates that the application supports a wearable computing device (e.g., a smart watch) that can be an accessory device that is coupled to a user device. A badge visually indicating support of an accessory device may represent compatibility of the accessory device with an application, and/or may indicate an expanded user experience is available when the accessory device identified in the badge is used with a particular application. A selection of the badge by the user may provide a list of one or more applications to the user device that are related to the application featuring the visual badge, and/or which may be compatible with or may provide an expanded user experience with the accessory device identified in the visual badge.

In example embodiments of the presently disclosed subject matter, a server may provide a user device with merchandised sets of relevant items when the user connects with the server's application store (i.e., “app store”). For example, if the user of the user device connecting to the app store has a wearable computing device that is an accessory device communicatively coupled to the user device (e.g., as identified by the accessory device data disclosed above), a server may provide a collection of the most popular applications which provide an expanded user experience for the coupling of the user's device with the wearable computing device that is the accessory device.

In the example described above, the collections can be displayed on the user device in a manner that provides an enhanced experience in recommending applications and/or accessory devices. For example, a server may present to the user device recommended collections only to users who meet a predetermined criteria (e.g., have an applications stored on their user device that may benefit from an expanded user experience when an accessory device is added), or are in a certain geographic location, or have used a particular accessory device (e.g., a wearable computing accessory device) recently (e.g., within the past day, week, month, or the like), or have their accessory device presently coupled to the accessory device.

In another example, at least one of the server 13, database 15, and remote platform 17 as illustrated in FIG. 2 may provide recommendations as to which accessory devices can provide an expanded user experience, with, for example, game applications. Recommendations may be provided for one or more accessory devices for a game application. When a user has a new controller and/or gamepad (e.g., that is determined according to the retrieved accessory device data, as described above), at least one of the server 13, database 15, and remote platform 17 can also recommend game applications that provide an expanded and/or improved game playing experience with a user's game controller and/or gamepad. When a user is viewing a list of games that may lead to a purchase and/or download of a game, the app store can identify, provide a message, or inform a user that the one or more games in the list provides works with and/or provides an expanded user experience with the controller that the user owns, or recommends a particular controller for purchase that would expand the user's experience with the game that is being viewed for purchase and/or download.

In example embodiments of the presently disclosed subject matter, at least one of the server 13, database 15, and remote platform 17 as illustrated in FIG. 2 may provide separate stores (i.e., “app stores”) for each accessory device type to identify expanded user experiences with an application for a particular accessory device. For example, at least one of the server 13, database 15, and remote platform 17 as illustrated in FIG. 2 may provide separate stores for game controller, video accessories, virtual reality headsets, display devices, keyboards, wearable computing devices, and the like.

Various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, such that when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, such that when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits.

In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A method comprising:
retrieving, by a server, device information data from a user device;
retrieving, by the server, accessory information data from one or more accessory devices determined to be communicatively coupled to the user device within a predetermined period of time according to the retrieved device information data;
retrieving, by the server, application data from the user device for applications stored on the user device; and
recommending, by the server that is communicatively coupled to a storage device having a database of applications and user experience data, at least one new accessory device to the user device according to user experience data, the retrieved application data, the retrieved device information data, and the accessory information data.

2. The method of claim 1, wherein the recommended at least one new accessory device provides an expanded user experience with one or more of the applications stored on the user device.

3. The method of claim 1, wherein the database of applications and user experience data includes data linking one or more accessory devices to one or more applications, respectively, to provide a predetermined expanded user experience with the one or more applications.

4. The method of claim 1, further comprising:
determining, by the server, that the user device is associated with the at least one new accessory device according to updated accessory information data retrieved from the user device.

5. The method of claim 4, further comprising:
recommending, by the server that is coupled to the storage device having the database of applications and user experience data, at least one new application from the database of applications according to the updated accessory information data.

6. The method of claim 1, further comprising:
tagging, by the server, at least one application in the storage device having the database of applications, so that accessory devices for a predetermined user experience level are identified.

7. The method of claim 1, further comprising:
determining, by the server that is coupled to the storage device having the database of applications and user experience data, at least one application to recommend according to the retrieved device information data and the accessory information data; and
filtering, by the server, the determined applications to recommend to the user of the user device, according to at least one of the retrieved device information data and the accessory information data.

8. The method of claim 1, wherein the recommending the at least one new accessory device by the server is performed without receiving user input from the user device.

9. The method of claim 1, wherein the recommending the at least one new accessory device by the server is performed without receiving a search request for at least one of an application and an accessory device from the user device.

10. A system comprising:
a user device;
one or more accessory devices determined to be communicatively coupled to the user device within a predetermined period of time;
a server, communicatively coupled to a storage device having a database of applications and user experience data, to retrieve device information data from the user device, accessory information data from the one or more accessory devices according to the retrieved device information data, and application data from the user device for applications stored on the user device, and to recommend at least one new accessory device to the user device according to user experience data, the retrieved application data, the retrieved device information data, and the accessory information data.

11. The system of claim 10, wherein the recommended at least one new accessory device provides an expanded user experience with one or more of the applications stored on the user device.

12. The system of claim 10, wherein the database of applications and user experience data includes data linking one or more accessory devices to one or more applications, respectively, to provide a predetermined expanded user experience with the one or more applications.

13. The system of claim 10, wherein the server determines that the user device is associated with the at least one new accessory device according to updated accessory information data retrieved from the user device.

14. The system of claim 13, wherein the server recommends at least one new application from the database of applications according to the updated accessory information data.

15. The system of claim 10, wherein the server tags at least one application in the storage device having the database of applications, so that accessory devices for a predetermined user experience level are identified.

16. The system of claim 10, wherein the server determines at least one application to recommend according to the retrieved device information data and the accessory information data, and filters the determined applications to recommend to the user of the user device, according to at least one of the retrieved device information data and the accessory information data.

17. The system of claim 10, wherein the server recommends the at least one new accessory device without receiving user input from the user device.

18. The system of claim 10, wherein the server recommends the at least one new accessory device without receiving a search request for at least one of an application and an accessory device from the user device.
